(19) United States
(12) Patent Application Publication
(10) Pub. No.: US 2011/0020570 A1
(43) Pub. Date: Jan. 27, 2011

(54) MATERIALS AND PROCESSES FOR FABRICATING CONTAINERS AND CONTAINERS FORMED THEREWITH

(75) Inventors: Robert L. Wadsworth, Crown Point, IN (US); Curtis Lee VanDyke, Grand Haven, MI (US); Dennis Allen Bardon, LaPorte, IN (US)

Correspondence Address: HARTMAN & HARTMAN, P.C., 552 EAST 700 NORTH, VALPARAISO, IN, 46383, US

(73) Assignee: INNOVATIVE ENERGY, INC., Lowell, IN (US)

(21) Appl. No.: 12/824,283

(22) Filed: Jun. 28, 2010

Related U.S. Application Data
(60) Provisional application No. 61/222,501, filed on Jul. 2, 2009.

(51) Int. Cl. B65D 5/42; B31B 1/62; B32B 3/02; B32B 7/02; B32B 29/06

(52) U.S. Cl. 428/34.2; 493/151; 428/215; 428/102; 428/81

(57) ABSTRACT

A sheet material and construction method suitable for manufacturing boxes and other types of containment devices, and containers formed with such materials and methods. According to one aspect, the sheet material includes a kraft paper, a reflective film material laminated to a first surface of the kraft paper, a heat-activated first adhesive bonding the reflective film material to the kraft paper, a core material laminated to a second surface of the kraft paper opposite the first surface thereof, and a heat-activated second adhesive bonding the kraft paper to the core material. According to an additional aspect, a sheet material is configured to have certain geometric features that promote its conversion into a container, especially if constructed of the sheet material described above.

### CROSS REFERENCE TO RELATED APPLICATIONS

This application claims the benefit of U.S. Provisional Application No. 61/222,501, filed Jul. 2, 2009, the contents of which are incorporated herein by reference.

### BACKGROUND OF THE INVENTION

The present invention generally relates to boxes and various other types of containment devices, and more particularly to boxes suitable for transporting and/or handling temperature-sensitive and/or moisture-sensitive materials.

Various types of boxes and containment devices have been developed for the purpose of transporting and handling temperature-sensitive and moisture-sensitive materials. Such boxes have been manufactured from sheet materials produced by lamination processes to have a reflective surface, which can then be converted by folding, gluing, etc., into a desired box configuration. The reflective surface may be a metallic film, for example, a low-emissivity film material joined to kraft paper with an adhesive. The manufacturing of such sheet materials and the construction of boxes from these materials can be difficult. As a particular example, adhesives used to bond the low-emissivity film material to the kraft paper have been prone to fail, resulting in sporadic product results in terms of the structural integrity of the boxes. Such previously unsuccessful attempts have indicated that different manufacturing processes, including modifications in the box configuration and the manufacture of the sheet material from which the box is converted, must be used to produce a viable product.

### BRIEF DESCRIPTION OF THE INVENTION

The present invention provides a sheet material and construction method suitable for manufacturing boxes and other types of containment devices, and containers formed with such materials and methods. The sheet material is capable of being used to construct boxes in a variety of sizes and styles, and is particularly well suited for the transport or handling of temperature-sensitive and/or moisture-sensitive materials.

According to a first aspect of the invention, the sheet material includes a kraft paper, a reflective film material laminated to a first surface of the kraft paper, a heat-activated first adhesive bonding the reflective film material to the kraft paper, a core material laminated to a second surface of the kraft paper opposite the first surface thereof, and a heat-activated second adhesive bonding the kraft paper to the core material. According to preferred aspects of the invention, the kraft paper has a grammage of about 60 to about 70 g/m², the reflective film material comprises a metallized polyester film having a thickness of about 10 to about 15 micrometers, the first adhesive is a low-density polyethylene blended with ethylene methacrylic acid and is present on a weight basis of greater than 10 g/m² and less than 20 g/m², the core material is a polystyrene foam having a thickness of about 4 to about 5 mm and a density of about 30 to 35 kg/m³, and the second adhesive is a polyester applied on a weight basis of greater than 10 g/m² and less than 20 g/m².

Other aspects of the invention include methods of producing containers (for example, boxes and other containment devices) from the sheet material described above, the containers formed thereby, and methods of using the containers.

According to an additional aspect of the invention, a sheet material is configured to have certain geometric features that promote its conversion into a container, especially if constructed of the sheet material described above.

Boxes, containers, and other containment devices constructed in accordance with this invention can be manufactured in a variety of sizes and styles for transporting and/or handling various different types of temperature- and/or moisture-sensitive materials, as well as for a variety of other applications. The invention is particularly well suited for the construction of boxes whose construction is capable of meeting various aesthetic objectives and/or whose use is capable of reducing the carbon footprint of shipping temperature- and moisture-sensitive materials.

Other aspects and advantages of this invention will be better appreciated from the following detailed description.

### BRIEF DESCRIPTION OF THE DRAWINGS

FIG. 1 is a perspective view of a regular slotted carton (RSC) box that can be produced in accordance with an embodiment of this invention.

FIG. 2 represents a plan view of a sheet material configured for constructing the box of FIG. 1.

FIG. 3 schematically represents a cross-sectional view of the sheet material of FIG. 2.

FIGS. 4 through 8 are detailed views of five regions in FIG. 2 identified as 4 through 8, and a comparison of these regions with prior art RSC boxes.

### DETAILED DESCRIPTION OF THE INVENTION

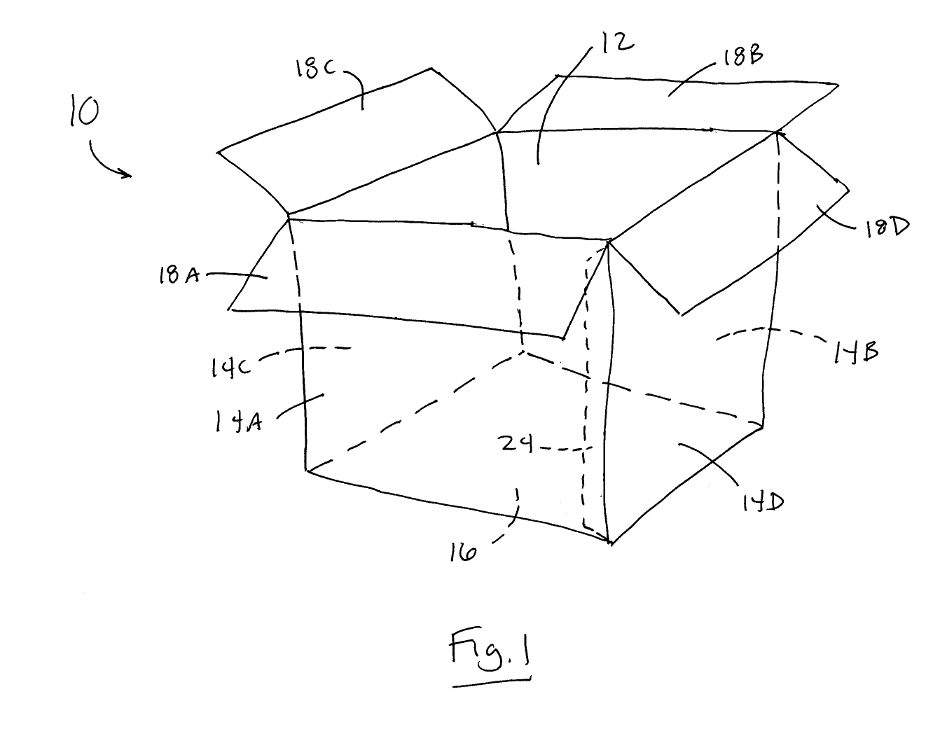

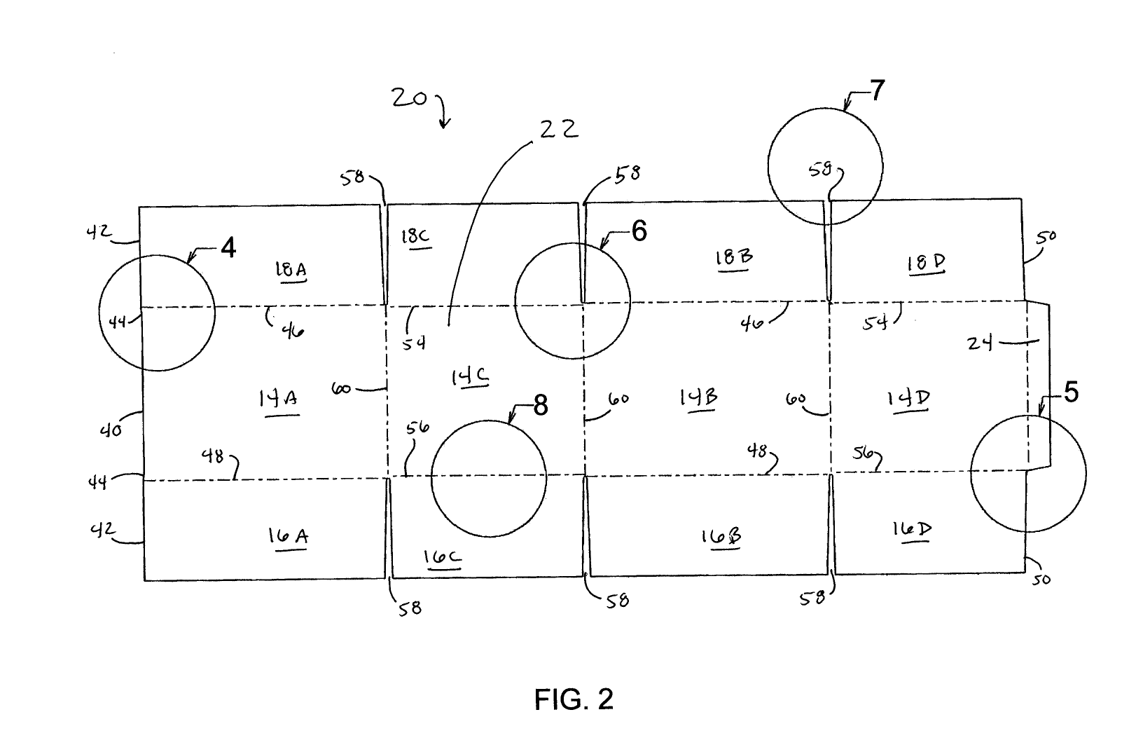

FIG. 1 represents a box 10 of a type that can be constructed from a blank of sheet material 20 represented in FIG. 2. The box 10 is represented as having the general configuration of an RSC box, characterized by an interior volume 12 defined by four side panels 14A-D, four bottom flaps (not shown) that form the bottom 16 of the box 10, and four top flaps 18A-D that are adapted to be folded to enclose the interior volume 12. To facilitate the descriptions of the box 10 and the sheet material 20 provided below, the terms “top,” “bottom,” “lateral,” etc., will be used in reference to the perspective of the orientation of the box 10 in FIG. 1, and therefore are relative terms and should not be otherwise interpreted as limitations to the construction and use of the box 10 or the sheet material 20.

FIG. 2 shows a surface 22 of the sheet material 20 that, when converted to form the box 10 of FIG. 1, defines the interior-facing surfaces surrounding the interior volume 12 of the box 10. As evident from FIG. 2, the sheet material 20 has been cut, such as with a die, to define the panels of the box 10 in FIG. 1. In particular, the sheet material 20 comprises the four side panels 14A-D, four bottom flaps 16A-D that form the bottom 16 of the box 10, and the four top flaps 18A-D that define the closing flaps of the box 10. An additional flap, referred to as a stitch tab 24, extends from the side panel 14D which, as evident from FIG. 1, enables the panel 14D to be glued or otherwise attached to the side panel 14A for closing the sides of the box 10. The surface 22 of the sheet material 20 seen in FIG. 2 is preferably reflective, such that thermal radiation emitted by the contents of the box 10 is reflected back into the interior volume 12 and its contents. For this purpose, the surface 22 of the sheet material 20 is defined by a reflective film material that exhibits low emissivity (preferably 0.05 or less). The film material is also preferably protected with a coating capable of inhibiting corrosion to maintain the high reflectance of the film material.

The sheet material 20 is manufactured and configured in a manner that promotes more consistent results in terms of the structural integrity of the box 10 constructed (converted) from the sheet material 20. In a preferred embodiment, the raw materials of the sheet material 20, including the reflective film material and the substrate to which the film material is applied, are structured to promote the ability of the sheet material 20 to produce a box (such as the box 10 of FIG. 1) and facilitate the process by which such a box can be made. The following describes raw materials and production processes that were determined to be optimal for consistently achieving desirable results.

As represented in FIG. 3, the sheet material 20 generally comprises the reflective film material 26 laminated with an adhesive layer 28 to a kraft paper 30, which in turn is bonded to a core material 32 with an adhesive 34. The film material 26 preferably comprises a low-emissivity metallization 36 on a polymer film 38. The core material 32 is preferably an extruded polystyrene (XPS) foam sheet, the metallization 36 is preferably aluminum, and the polymer film 38 is preferably a polyester material. Ultimately, various combinations of changes to the kraft paper 30, core material 32, adhesives 28 and 34, polymer film 38 and lamination conditions were investigated prior to the eventual production of a durable box 10.

The following aspects of the invention were determined to particularly affect the propensity for failure of the adhesive bond between kraft papers and reflective film materials that were observed in the prior art. The weight of the kraft paper 30 was determined to affect the reliability of the adhesion between the kraft paper 30 and the reflective film material 26, with lower-weight kraft paper 30 providing the greatest reliability. Furthermore, the reflective film material 26 was also determined to promote reliability of the bond if formed of a higher-blend metallized polyester, with a preferred material being metallized polyethylene terephthalate (MPET) film. Further optimization is achieved if the adhesive 28 is a heat-activated blend of a low-density polyethylene (LDPE) and ethylene methacrylic acid (EMAA), and the adhesive 34 is a heat-activated polyester (PE) blend. As discussed below, these particular materials for the adhesives 28 and 34 were determined to promote the lamination of the MPET film material 26 to the kraft paper 30 and then the subsequent lamination of the laminate to the polystyrene foam core material 32 at relative low temperatures and standard lamination speeds.

Another challenge was to modify the extrusion and lamination processes for the core material 32 so that the lamination formed by the reflective film material 26 and kraft paper 30 could be laminated onto the core material 32. For this purpose, the core material 32 was modified during the extrusion process to produce a relatively thin, low density polystyrene foam that promoted heat-activated adhesion of the lamination, which in turn facilitated the ability to laminate these materials at relatively low temperatures but at typical lamination speeds.

The modifications mentioned above are described in more detail below, and evidence that a combination of specific characteristics for the above-noted variables was optimized to consistently produce a viable box product.

Kraft paper having a basis weight of 40# (40 lbs/ream, or about 65 g/m²), was found to be optimal for a viable box product (ream is used in its ordinary sense to mean a basis ream having a surface area of 3000 square feet). Kraft paper weights ranging from 15# to 50# (about 24 to about 81 g/m²) were investigated by laminating reflective MPET films and extruded polystyrene foam materials. Paper weights below 40#, for example, 30# (about 49 g/m²) and less, resulted in a less rigid product that promoted delamination between the paper and the MPET films. On the other hand, weights above 40#, for example, 50# (about 81 g/m²) and higher, were determined to necessitate greater amounts of the adhesive 28 and higher temperatures during the lamination process, which was also determined to promote delamination between the kraft papers and MPET films, as well as cause heat marks on the finished lamination. On this basis, kraft paper 30 having a grammage of about 60 to about 70 g/m² is believed to be suitable.

For the reflective film material 26, an MPET film having a thickness of about 48 gauge (about 0.00048 inch; about 12 micrometers) as the polymer film 38 and bonded to the above-noted kraft paper 30 with LDPE blended with EMAA as the adhesive 28 was found to be optimal for producing a viable box product. During investigations, MPET films ranging from 30 gauge to 60 gauge (about 8 to about 15 micrometers) were tested by lamination to 40# kraft paper using LDPE adhesives applied at rates of about 5 to about 25 lbs/ream (about 8 to about 41 g/m²) and having EMAA contents of about 5% to about 15% by weight. Lower gauge MPET films (below 48 gauge) were determined to have an adverse effect on the emissivity of the reflective film material 26, whereas higher gauge MPET films (above 48 gauge) required greater amounts of adhesive, which during the lamination process tended to melt and then extrude from between the MPET film and kraft paper to promote delamination in addition to creating a mess. These problems were exacerbated with LDPE adhesives having a weight basis above and below 10 lbs/ream (about 16 g/m²) and EMAA contents above and below about 9% by weight. On this basis, an MPET film having a thickness of about 12 micrometers, for example, about 10 to 15 micrometers, is believed to be suitable for the polymer film 38. Furthermore, LDPE applied on a weight basis of about 10 lbs/ream (about 16 g/m²), for example, greater than 10 g/m² and less than 20 g/m², is believed to be suitable for the adhesive 28, particularly if blended to contain about 9 weight percent EMAA.

PE was found to be optimal as the adhesive 34 that adheres the above-noted kraft paper 30 to a polystyrene foam material. During investigations, PE applied at rates of about 5 to about 20 lbs/ream (about 8 to about 33 g/m²) was tested between the 40# kraft paper and polystyrene foam material. Similar to the observations seen with the LDPE adhesive 28, excessive melting, extrusion and delamination were observed with PE adhesives applied at rates above and below about 10 lbs/ream (about 16 g/m²). On this basis, PE applied on a weight basis of about 10 lbs/ream (about 16 g/m²), for example, greater than 10 g/m² and less than 20 g/m², is believed to be suitable for the adhesive 34.

Lamination temperatures were also determined to be important. With the materials noted above for the reflective film material 26, kraft paper 30 and adhesives 28 and 34, a lamination temperature of about 400° F. (about 205° C.) was determined to be optimal following investigations employing multiple different temperatures in combination with various weights and types of adhesives used. Temperatures above 400° F. promoted excessive melting of the adhesives and delamination, and temperatures below 400° F. were determined to not provide sufficient heat to bond to a polystyrene foam material, thus promoting delamination during cooling. On this basis, lamination temperatures of greater than 375° F. and less than 425° F. (about 190 to about 220° C.) are believed to be suitable.

Various thicknesses and densities were also investigated for the polystyrene foam core material 32. The investigations determined that thicknesses below about 0.175 inch (about 4.5 mm) didn't provide the needed rigidity for the finished product, whereas thicknesses above 0.175 inch were too rigid for implementing a satisfactory box-making process, including bending of the foam core material 32. In addition, foam densities of about 2.2 lbs/ft³ to about 3.2 lbs/ft³ (about 32 to about 51 kg/m³) were investigated, by which it was determined that higher densities led to poorer control of foam thickness during the lamination process as a result of the higher temperatures necessary to achieve lamination, which caused the foam material to expand beyond the desired thickness. On this basis, extruded polystyrene foam having a thickness of about 0.175 inch (about 4.5 mm) and a density of about 2.2 lbs/ft³ (about 32 kg/m³) was concluded to be optimal, with a suitable thickness range believed to be about 4 to about 5 mm and a suitable density range of about 30 to 35 kg/m³.

On the basis of the above, the resulting sheet material 20 can be described as a kraft paper 30 of a particular weight, laminated with a low-emissivity metallized polyethylene terephthalate (MPET) film material 26 using a heat-activated polyester-based adhesive 28, which is then laminated onto a thin extruded low-density polystyrene foam core material 32 using a second heat-activated polyester-based adhesive 34. Advantageously, this construction also allows for the fabrication of grooves and bends necessary to produce the box 10 of FIG. 1 from the sheet material 20 of FIG. 2, as described below.

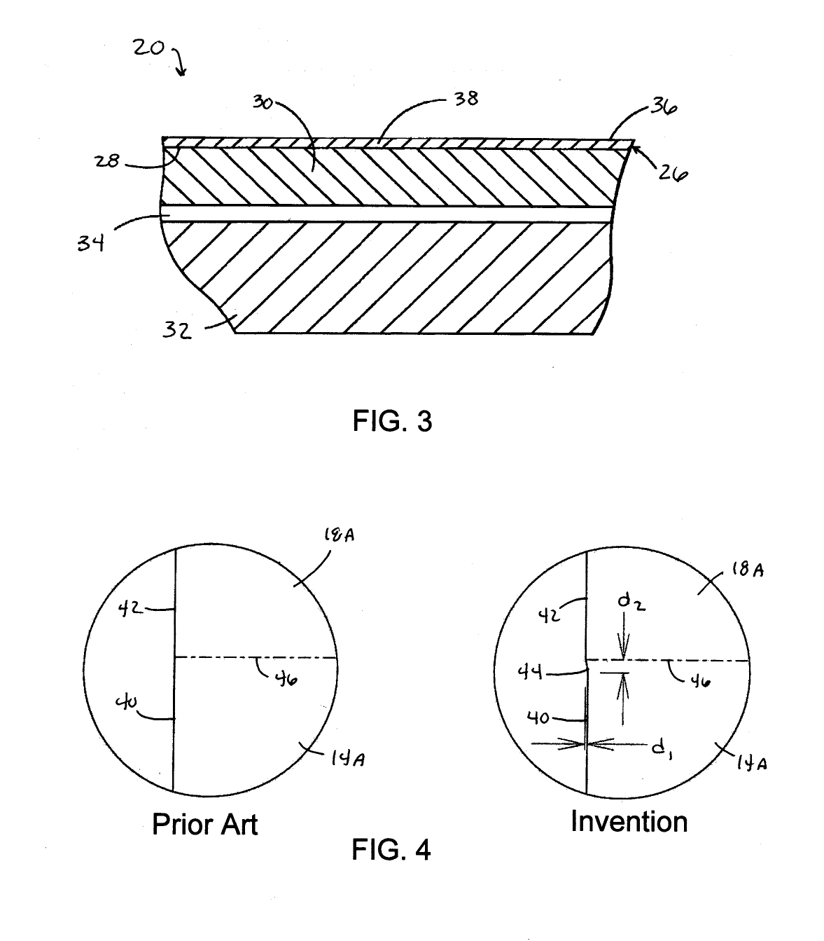

For addressing the conversion of the sheet material 20 into a variety of box configurations, such as the box 10 of FIG. 1, a structural design was desired that would enable the box 10 to be manufactured on conventional converting equipment used in the corrugated packaging industry. The following features relating to the design (geometry) of the sheet material 20 were developed to enable the manufacture of an RSC box (FIG. 1) that would be as close to airtight as possible after the conversion process. To do this, it was necessary to take into consideration the normal variations that would occur in the manufacturing operation, and then design the box 10 so that there would not be any openings around stitched joints or where the panels 14A-D, 16A-D and 18A-D meet, including the top flaps 18A-D that define the closing flaps of the box 10. Specific features are described below and illustrated in the detailed views of FIGS. 4 through 8 labeled as “Invention,” which are placed alongside corresponding detailed views of a blank of a “Prior Art” sheet material used to construct RSC boxes of the prior art. For convenience, consistent reference numbers are used throughout FIGS. 4 through 8 to identify corresponding structures of the prior art sheet and the sheet material 20 of the invention, though differences between these materials will be evident from the figures and the following discussion.

To reduce the gap normally found at the joint with an outside stitched box, the edge 40 of the panel 14A between the bottom and top flaps 16A and 18A was offset by a distance d₁ of about 1/16 inch (about 1.5 mm) from the adjacent edges 42 of the flaps 16A and 18A. As more readily seen in FIG. 4, the offset 44 of the edge 40 preferably commences a distance d₂ from the flap score 46 between the side panel 14A and top flap 18A and terminates an equal distance from the flap score 48 between the side panel 14A and bottom flap 16A. This distance d₂ is preferably about ⅜ inch (about 10 mm).

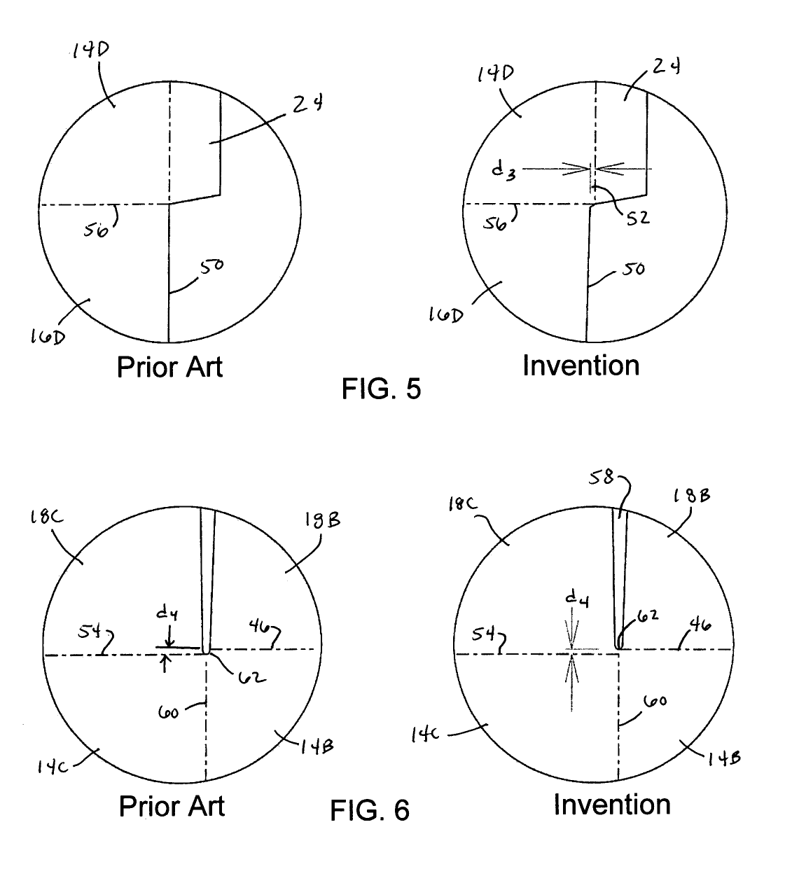

The offset distance d₁ shown in FIG. 4 necessitated offsetting the stitch tab 24 from the adjacent edges 50 of the bottom and top flaps 16D and 18D, as shown in FIG. 5, so that the panels 14A and 14 D and flaps 16A, 16D, 18A and 18D would properly meet and fold at their respective joints. The resulting extension 52 is identified by a distance d₃ in FIG. 5, and is greater than the offset distance d₁ of FIG. 4. This distance d₃ is preferably about ⅛ inch (about 3 mm).

The Prior Art detailed view in FIG. 6 shows conventional flap scores 46 and 54 separating two adjacent top flaps 18B and 18C from their adjacent side panels 14B and 14C, and the flaps 18B and 18C separated by a slot 58 that is collinear with a score 60 separating the panels 14B and 14C and terminates at the score 54. As shown in FIG. 6 and as also evident from FIG. 2, the scores 46 and 54 are offset a distance d₄ from each other so as not to be collinear in order to allow the top flaps 18B and 18C to compensate for the thickness of the sheet material as the flaps 18B and 18C are closed. As shown in FIG. 2, the scores 48 and 56 separating the bottom flaps 16A and 16B and top flaps 18A and 18B from their adjacent side panels 14A and 14B are similarly offset from each other for the same reason. In the detailed view showing the invention in FIG. 6, instead of terminating at the score 54, the termination 62 of the slot 58 is located at the score 46, which is nearer the distal edges of the flaps 18B and 18C than the more interior score 54, so that when the flaps 18B and 18C are closed, their intersection point (coinciding with the termination 62) becomes a pinch point closing off the corners of the box 10.

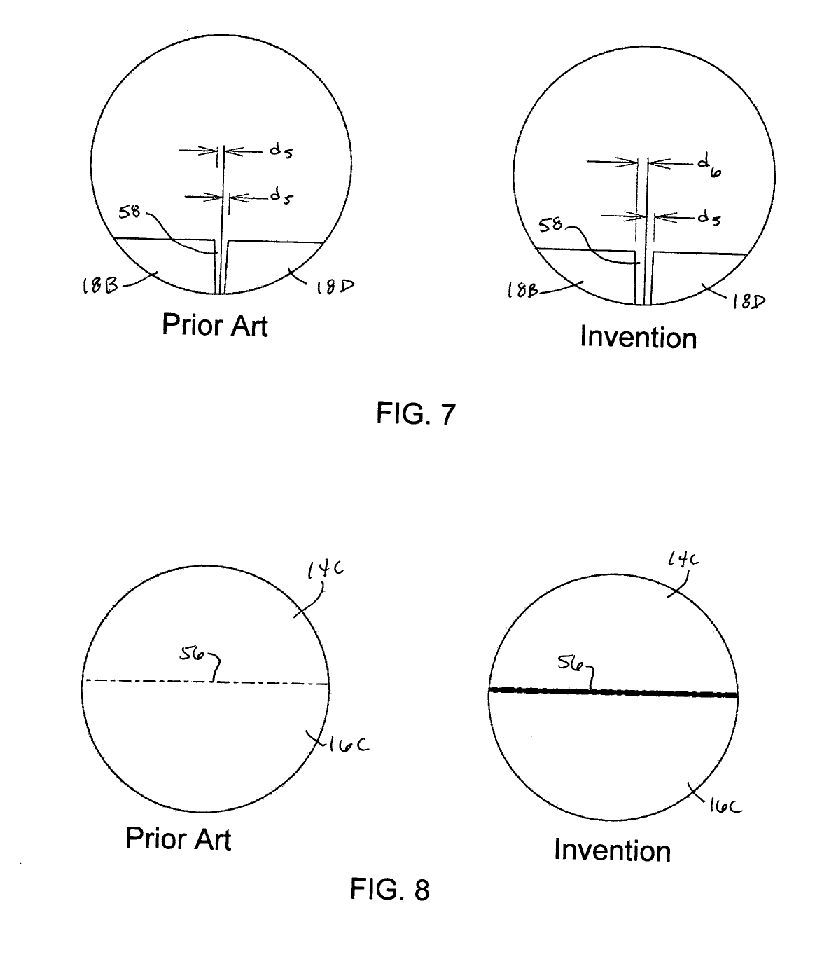

To allow for scrap material to eject from a cutting die during the conversion process by which the box 10 is produced from the sheet material 20, the tapers of the slots 58 were modified as shown in FIG. 7. In the Prior Art and Invention views of FIG. 7, a midline between the larger (major) and smaller (minor) flaps 18B and 18D is collinear with the panel scores 60. In the Prior Art view, the taper distances d₅ from the midline to the lateral edges of the flaps 18B and 18D are equal. For the invention, a greater “offset” distance d₆ was provided for the larger flap 18B, such that the lateral edge of the larger flap 18B is farther from the midline than the lateral edge of the smaller flap 18D. The same applies to each adjacent pair of larger flaps 16A, 16B, 18A and 18B and smaller flaps 16C, 16D, 18C and 18D. The benefit of this configuration is to avoid the creation of a gap along the edge of the smaller flap (18D) as it is folded toward the inside of the box 10. Exemplary values for these distances d₅ and d₆ are about 9/32 inch and about 7/32 inch (about 7 and about 5.5 mm), respectively.

Unlike corrugated board conventionally used in the construction of boxes, the MPET/foam construction of the sheet material 20 has a resiliency after the scores 46, 48, 54, 56 and 60 are formed in the sheet material 20 with a cutting die. This resiliency resulted in the sheet material 20 being more difficult to fold for stitching. As represented in FIG. 8, the score 56 between the side panel 14C and lower flap 16C has a wider profile (for example, eight point) as compared to the narrower profile (for example, four point) of the prior art to reduce resiliency and improve folding. The wider profile is equally applicable to all of the scores 46, 48, 54, 56 and 60 in the sheet material 20.

As with corrugated board, allowances or an addition to dimensions are preferably added to compensate for sheet material 20 lost in the actual fold of the box 10. In order to reduce the variation at the joint and create a tighter fit, the width of the panel 14D from which the stitch tab 24 extends can be reduced to less than that of its opposing panel 14C. This difference in width can be, for example, about 1/16 inch (about 1.5 mm).

There are a variety of ways that changes might be made to produce variations of the sheet material 20 and box 10 described above, including the use of various other types of films and facers. For example, aluminum foil could be used in place of the metallization 36 of the reflective film material 26, and a variety of other types of metallized plastic films and kraft paper could be used. In addition to extruded polystyrene foam, the core material 32 of the sheet material 20 could be made with, for example, expanded polystyrene, corrugated and/or fluted plastic, or standard corrugated kraft paper box material. Various box/container styles are also within the scope of the invention, including the RSC box 10 represented in FIG. 1, as well as mailers, catering boxes, FOL RSC boxes, CSSC RSC boxes, five panel folder boxes, lid style boxes, to-go boxes, and round catering boxes.

In view of the above, while the invention has been described in terms of specific embodiments, it is apparent that other forms could be adopted by one skilled in the art. Therefore, the scope of the invention is to be limited only by the following claims.

1. A sheet material adapted for conversion into a container, the sheet material comprising:
a kraft paper having a grammage of about 60 to about 70 g/m²;
a reflective film material laminated to a first surface of the kraft paper, the reflective film material comprising a metallized polyester film having a thickness of about 10 to about 15 micrometers;
a heat-activated first adhesive bonding the reflective film material to the kraft paper, the first adhesive being a low-density polyethylene blended with ethylene methacrylic acid, the first adhesive being present on a weight basis of greater than 10 g/m² and less than 20 g/m²;
a core material laminated to a second surface of the kraft paper opposite the first surface thereof, the core material being a polystyrene foam having a thickness of about 4 to about 5 mm and a density of about 30 to 35 kg/m³; and
a heat-activated second adhesive bonding the kraft paper to the core material, the second adhesive being a polyester applied on a weight basis of greater than 10 g/m² and less than 20 g/m².

2. The sheet material according to claim 1, wherein the kraft paper has a grammage of about 65 g/m².

3. The sheet material according to claim 1, wherein the reflective film material has a thickness of about 12 micrometers.

4. The sheet material according to claim 1, wherein the first adhesive is present on a weight basis of about 16 g/m².

5. The sheet material according to claim 1, wherein the metallized polyester film of the reflective film material is a metallized polyethylene terephthalate film.

6. The sheet material according to claim 1, wherein the first adhesive contains about 9 weight percent ethylene methacrylic acid.

7. The sheet material according to claim 1, wherein the core material has a thickness of about 4.5 mm and a density of about 32 kg/m³.

8. The sheet material according to claim 1, wherein the sheet material further comprises:
a series of contiguous panels comprising first, second, third and fourth panels separated from each other by panel scores, each of the first, second, third and fourth panels having a top side and an oppositely-disposed bottom side;
a series of first, second, third and fourth bottom flaps that are located at the bottom sides of the first, second, third and fourth panels, are separated from each other by bottom slots, and are separated from the first, second, third and fourth panels by first, second, third and fourth bottom flap scores, respectively, each of the first, second, third and fourth bottom flaps having oppositely-disposed lateral edges that terminate at a distal edge relative to the first, second, third and fourth panels;
a series of first, second, third and fourth top flaps that are located at the top sides of the first, second, third and fourth panels, are separated from each other by top slots, and are separated from the first, second, third and fourth panels by first, second, third and fourth top flap scores, respectively, each of the first, second, third and fourth top flaps having oppositely-disposed lateral edges that terminate at a distal edge relative to the first, second, third and fourth panels; and
a stitch tab protruding from a lateral side of the fourth panel between the top and bottom sides thereof, the stitch tab being adapted for bonding to the first panel by folding the panel scores between the first and second panels, between the second and third panels, and between the third and fourth panels.

9. A method comprising converting the sheet material of claim 8 into a container by folding the sheet material along the panel scores and the first, second, third and fourth bottom flap scores, and then bonding the stitch tab to the first panel.

10. The container produced by the method of claim 9.

11. A method comprising converting the sheet material of claim 1 into a container by scoring the sheet material to form scores and then folding the sheet material along the scores.

12. The container produced by the method of claim 11.

13. A method of using the container of claim 11, the method comprising placing and transporting a temperature-sensitive material and/or a moisture-sensitive material within the container.

14. A sheet material adapted for conversion into a container, the sheet material comprising:
a series of contiguous panels comprising first, second, third and fourth panels separated from each other by panel scores, each of the first, second, third and fourth panels having a top side and an oppositely-disposed bottom side;
a series of first, second, third and fourth bottom flaps that are located at the bottom sides of the first, second, third and fourth panels, are separated from each other by bottom slots, and are separated from the first, second, third and fourth panels by first, second, third and fourth bottom flap scores, respectively, each of the first, second, third and fourth bottom flaps having oppositely-disposed lateral edges that terminate at a distal edge relative to the first, second, third and fourth panels;
a series of first, second, third and fourth top flaps that are located at the top sides of the first, second, third and fourth panels, are separated from each other by top slots, and are separated from the first, second, third and fourth panels by first, second, third and fourth top flap scores, respectively, each of the first, second, third and fourth top flaps having oppositely-disposed lateral edges that terminate at a distal edge relative to the first, second, third and fourth panels; and
a stitch tab protruding from a lateral side of the fourth panel between the top and bottom sides thereof, the stitch tab being adapted for bonding to the first panel by folding the panel scores between the first and second panels, between the second and third panels, and between the third and fourth panels;
wherein the first panel has a lateral edge between the first top flap and the first bottom flap that is recessed relative to the adjacent lateral edges of the first top flap and the first bottom flap;
wherein the lateral side of the fourth panel from which the stitch tab protrudes extends laterally outward relative to adjacent lateral edges of the fourth top flap and the fourth bottom flap;
wherein the first, second, third and fourth top flap scores are alternatingly offset from each other so that the first and third top flap scores are collinear with each other and the second and fourth top flap scores are collinear with each other and farther from the distal edges of the second and fourth top flaps than are the first and third top flap scores from the distal edges of the first and third top flaps;
wherein the top and bottom slots are collinear with the panel scores, the top slots terminate at the first and third top flap scores, and the bottom slots terminate at the first and third bottom flap scores; and
wherein the first, second, third and fourth top flaps and the first, second, third and fourth bottom flaps are each tapered to be narrower at their respective distal edges, a midline exists between each adjacent pair of the first, second, third and fourth top flaps and between each adjacent pair of the first, second, third and fourth bottom flaps, the midlines are collinear with the panel scores, and the lateral edges of the first and third top flaps and the first and third bottom flaps are farther from the midlines than the lateral edges of the second and fourth top flaps and the second and fourth bottom flaps.

15. The sheet material according to claim 14, wherein the lateral side of the fourth panel from which the stitch tab protrudes extends laterally outward from the adjacent lateral edges of the fourth top and bottom flaps than a distance that the lateral edge of the first panel is recessed.

16. The sheet material according to claim 14, wherein each of the second and fourth panels has a lateral width, and the lateral width of the fourth panel is less than the lateral width of the second panel.

17. The sheet material according to claim 14, wherein the sheet material further comprises:
a kraft paper having a grammage of about 60 to about 70 g/m²;
a reflective film material laminated to a first surface of the kraft paper, the reflective film material comprising a metallized polyester film having a thickness of about 10 to about 15 micrometers;
a heat-activated first adhesive bonding the reflective film material to the kraft paper, the first adhesive being a low-density polyethylene blended with ethylene methacrylic acid, the first adhesive being present on a weight basis of greater than 10 g/m² and less than 20 g/m²;
a core material laminated to a second surface of the kraft paper opposite the first surface thereof, the core material being a polystyrene foam having a thickness of about 4 to about 5 mm and a density of about 30 to 35 kg/m³; and
a heat-activated second adhesive bonding the kraft paper to the core material, the second adhesive being a polyester applied on a weight basis of greater than 10 g/m² and less than 20 g/m².

18. A method comprising converting the sheet material of claim 14 into a container by folding the sheet material along the panel scores and the first, second, third and fourth bottom flap scores, and then bonding the stitch tab to the first panel.

19. The container produced by the method of claim 18.

20. A method of using the container of claim 18, the method comprising placing and transporting a temperature-sensitive material and/or a moisture-sensitive material within the container.
